(19) United States
(12) Patent Application Publication
(10) Pub. No.: US 2017/0082810 A1
(43) Pub. Date: Mar. 23, 2017

(54) OPTICAL CONNECTOR AND METHOD FOR PRODUCING OPTICAL CONNECTOR

(71) Applicants: FUJITSU COMPONENT LIMITED, Tokyo (JP); FUJITSU LIMITED, Kawasaki-shi (JP)

(72) Inventors: Osamu Daikuhara, Tokyo (JP); Rie Gappa, Tokyo (JP); Takatoshi Yagisawa, Kawasaki (JP)

(21) Appl. No.: 15/259,249

(22) Filed: Sep. 8, 2016

(30) Foreign Application Priority Data
Sep. 17, 2015 (JP) 2015-184508

(51) Int. Cl. G02B 6/42

(52) U.S. Cl. CPC G02B 6/4224; G02B 6/4292

(57) ABSTRACT

An optical connector includes an optically-transparent substrate, a first optical component mounted on a first surface of the substrate, and a second optical component mounted on a second surface of the substrate. The substrate includes a marker that is formed on one of the first surface and the second surface and recognizable from the other one of the first surface and the second surface.

### CROSS-REFERENCE TO RELATED APPLICATION

The present application is based upon and claims the benefit of priority of Japanese Patent Application No. 2015-184508, filed on Sep. 17, 2015, the entire contents of which are incorporated herein by reference.

### BACKGROUND OF THE INVENTION

1. Field of the Invention

An aspect of this disclosure relates to an optical connector and a method for producing the optical connector.

2. Description of the Related Art

With the increase in the capacity of optical communications, there is a demand for high-density, smaller optical modules for optical connectors. Also, because there is a limit in increasing the speed of electric communications due to cross talks and wiring density, it is being considered to use an optical connector, which includes a photoelectric converter for converting an electric signal into an optical signal, to employ optical communications and increase the transmission capacity.

An optical connector conforming to QSFP (Quad Small Form-factor Pluggable) standards includes, in a housing, a substrate on which electronic components including a photoelectric converter are mounted, an MT (Mechanically Transferrable) ferrule to which a multicore optical fiber is connected, a lens ferrule optically connected to the MT ferrule, and an optical waveguide which is connected to the photoelectric converter and to the lens ferrule.

Also, there is a known optical connector having a configuration where optical devices such as a light-emitting device and a light-receiving device are mounted on a substrate in a “face-down” manner, an optical waveguide is provided on an opposite surface of the substrate that is opposite the surface on which the optical devices are mounted, and the optical devices are optically connected to the optical waveguide via light passages formed in the substrate (see, for example, Japanese Laid-Open Patent Publication No. 2015-023143, Japanese Laid-Open Patent Publication No. 2012-068539, and Japanese Patent No. 5505140). In producing this type of optical connector, it is necessary to accurately position and mount the optical devices and the optical waveguide on the substrate.

In a known method of positioning optical devices and an optical waveguide on a substrate, a first marker is formed on a first surface of the substrate, a second marker is formed on a second surface of the substrate separately from the first marker, the optical devices are positioned with reference to the first marker and mounted on the first surface, and the optical waveguide is positioned with reference to the second marker and mounted on the second surface.

The first marker is formed on the first surface as a pattern using a mask. The second marker is formed on the second surface as a pattern using a different mask.

Patterns formed on the same surface using the same mask can be accurately positioned relative to each other. However, because the first marker and the second marker are formed in separate steps using different masks, the first marker and the second marker may be misaligned with each other.

If the first marker and the second marker are misaligned with each other, the optical devices mounted on the substrate with reference to the first marker are misaligned with the optical waveguide and optical path holes mounted and formed with reference to the second marker.

For example, when the position of the light-emitting device is misaligned with the position of the optical waveguide, an optical loss occurs in the light that is emitted from the light-emitting device and enters the optical waveguide. Also, when the position of an optical path hole formed in the substrate is misaligned with the light-emitting device, light emitted from the light-emitting device does not enter the optical path hole and an optical loss occurs between the light-emitting device and the optical waveguide.

### SUMMARY OF THE INVENTION

In an aspect of this disclosure, there is provided an optical connector that includes an optically-transparent substrate, a first optical component mounted on a first surface of the substrate, and a second optical component mounted on a second surface of the substrate. The substrate includes a marker that is formed on one of the first surface and the second surface and recognizable from the other one of the first surface and the second surface.

### BRIEF DESCRIPTION OF THE DRAWINGS

FIG. 1 is an exploded perspective view of an optical connector according to an embodiment;

FIGS. 2A and 2B are drawings illustrating an optical module according to an embodiment;

FIG. 3 is an enlarged view of a part of an optical module where optical devices are mounted;

FIG. 4 is a cross-sectional view taken along line A-A of FIG. 3;

FIG. 5 is a table illustrating characteristics of substrates used for an optical module;

FIGS. 6A through 6F are drawings illustrating an exemplary process of producing an optical connector;

FIGS. 7A through 7C are drawings illustrating an exemplary process of producing an optical connector;

FIGS. 8A through 8C are drawings illustrating an exemplary process of producing an optical connector; and

FIGS. 9A and 9B are drawings illustrating other examples of a lower-surface marker.

### DESCRIPTION OF EMBODIMENTS

An aspect of this disclosure provides an optical connector and a method of producing the optical connector that can accurately determine the relative positions of an optical component on a surface of a substrate and an optical component on another surface of the substrate.

Embodiments of the present invention are described below with reference to the accompanying drawings.

Throughout the accompanying drawings, the same or corresponding reference numbers are assigned to the same or corresponding components, and repeated descriptions of those components are omitted. Unless otherwise mentioned, the drawings do not indicate relative sizes of components. A person skilled in the art may determine actual sizes of components taking into account the embodiments described below.

The embodiments described below are examples, and the present invention is not limited to those embodiments. Also, not all of the features and their combinations described in the embodiments may be essential to the present invention.

In the drawings, directions are indicated by arrows X1, X2, Y1, Y2, Z1, and Z2. In the descriptions below, an X1 side may be referred to as a “module side”, an X2 side may be referred to as a “cable side”, and an X1/X2 direction may be referred to as a “longitudinal direction”. A Y1/Y2 direction that is orthogonal to the longitudinal direction on a plane of a printed-circuit board 101 may be referred to as a “width direction”. A Z1/Z2 direction that is orthogonal to the longitudinal direction and the width direction may be referred to as a “height direction” or “vertical direction”.

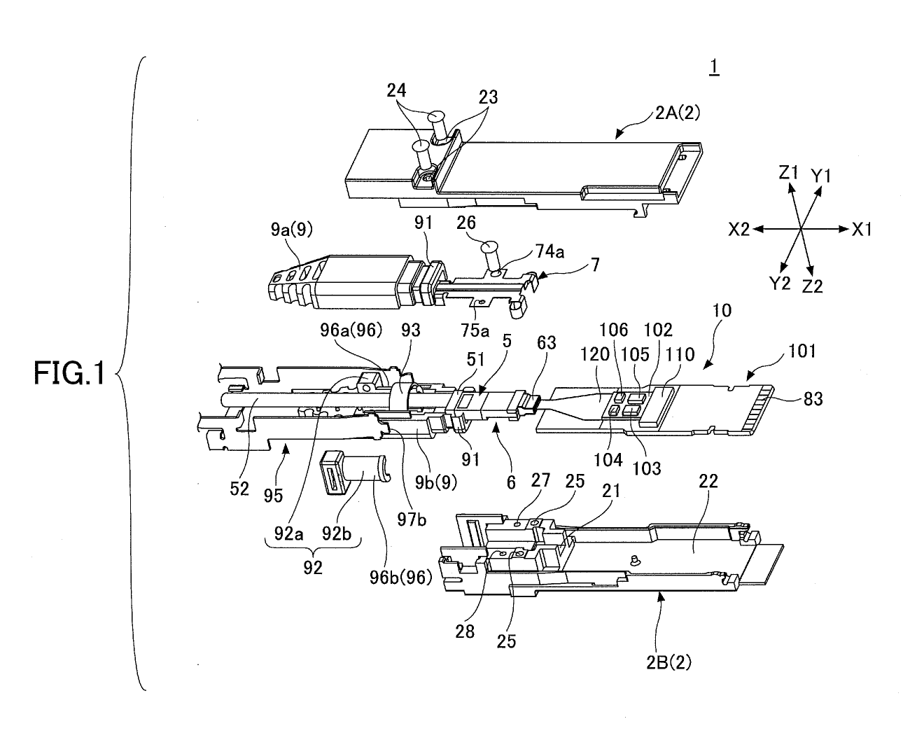

FIG. 1 is an exploded perspective view of an optical connector 1 according to an embodiment. The optical connector 1 is a high-density optical connector conforming to the QSFP standards. The optical connector 1 includes a housing 2, an MT ferrule 5, a lens ferrule 6, and an optical module 10.

For example, the optical connector 1 may be used for Ethernet (registered trademark), and may be inserted into a computer-side module (not shown) of a large computer system. In FIG. 1, the X1 direction corresponds to the direction in which the optical connector 1 is inserted into the computer-side module.

The housing 2 includes an upper housing 2A and a lower housing 2B. The upper housing 2A includes insertion holes 23. The lower housing 2B includes screw holes 25. Screws 24 are inserted into the insertion holes 23 and screwed into the screw holes 25 to join the upper housing 2A and the lower housing 2B.

The housing 2 houses the MT ferrule 5, the lens ferrule 6, a clip 7, a cable boot 9, and the optical module 10.

A multicore optical cable (hereinafter referred to as “cable”) 52 including multiple optical fibers is connected to a cable-side end of the MT ferrule 5. Also, an abutting surface to be butted against the lens ferrule 6 is formed at a module-side end of the MT ferrule 5.

The lens ferrule 6 is formed of a transparent resin such as polybutylene succinate (PBS). A mirror-equipped macromolecular-polymer optical waveguide 120 (hereafter referred to as the “waveguide”) is connected to a module-side end of the lens ferrule 6. The lens ferrule 6 includes an abutting surface that is formed at a cable-side end of the lens ferrule 6 and to be butted against the MT ferrule 5.

The cable 52 and the waveguide 120 are optically connected to each other by butting the abutting surface of the MT ferrule 5 against the abutting surface of the lens ferrule 6.

The clip 7 keeps the MT ferrule 5 and the lens ferrule 6 butted against each other by the elastic force of the clip 7. The clip 7 is a monolithic component formed of a spring material. The clip 7 is attached to pinch the MT ferrule 5 and the lens ferrule 6 whose abutting surfaces are butted against each other. When attached, a cable-side end of the clip 7 engages with the MT ferrule 5, and a module-side end of the clip 7 engages with the lens ferrule 6.

The cable boot 9 prevents the cable 52 from being pulled out of the MT ferrule 5. The cable boot 9 is formed by joining half parts 9a and 9b that sandwich the cable 52. The cable 52 is disposed to pass through the inside of the cable boot 9.

A lock 91 that engages with the housing 2 is formed at a module-side end of the cable boot 9. The lock 91 engaging with the housing 2 prevents the cable boot 9 from moving in the longitudinal direction relative to the housing 2, i.e., in a direction in which the optical connector 1 is inserted into or pulled out of the computer-side module.

A sleeve 92 and a crimp ring 93 are disposed in the cable boot 9. The cable 52 passes through the sleeve 92.

The sleeve 92 includes sleeve half parts 92a and 92b that include tubular half parts 96a and 96b. The tubular half parts 96a and 96b form a tubular part 96. When the sleeve half part 92a and the sleeve half part 92b are joined to each other, the cable 52 is sandwiched between the tubular half parts 96a and 96b. The diameter of an insertion hole formed inside of the tubular part 96 is slightly less than the diameter of the cable 52 that is inserted into the insertion hole.

The crimp ring 93 is put around the tubular part 96 formed by joining the tubular half parts 96a and 96b. When the sleeve 92 is attached to the cable 52 and the crimp ring 93 is attached to crimp the tubular part 96, the cable 52 is fixed to the sleeve 92, and the cable 52 and the sleeve 92 form an integral structure. Also, the sleeve 92 is configured to engage with the cable boot 9. This configuration can prevent the cable 52 from being detached from the optical module 10 even when a force to pull out the cable 52 is applied.

A pull tab 95 is used to pull out the optical connector 1 from an electronic apparatus.

The optical module 10 includes a printed-circuit board (“board”) 101, an optically-transparent substrate 102, a transimpedance amplifier (TIA) 103, a light-receiving device 104, a driving integrated circuit (IC) 105, a light-emitting device 106, a waveguide 120, and a lens sheet 140.

The optical module 10 and the cable boot 9 are attached to the housing 2. The lower housing 2B includes a module attaching part 21 to which the optical module 10 is attached, and a board attaching part 22 to which the board 101 is attached.

To attach the optical module 10 to the housing 2, the optical module 10 is inserted together with the cable boot 9 into the module attaching part 21. When the optical module 10 is inserted into the lower housing 2B, a hole 74a of the clip 7 faces a hole 27 of the lower housing 2B, and a boss 28 of the lower housing 2B is inserted into a hole 75a of the clip 7.

A screw 26 is inserted into the hole 74a and screwed into the hole 27, and the boss 28 is fused. As a result, the optical module 10 is fixed to the lower housing 2B. Also, the board 101 is bonded with an adhesive to the attaching part 22.

After the optical module 10 and the board 101 are attached to the lower housing 2B, the upper housing 2A is placed on the lower housing 2B, and the screws 24 are inserted into the holes 23 and screwed into the holes 25 to assemble the optical connector 1.

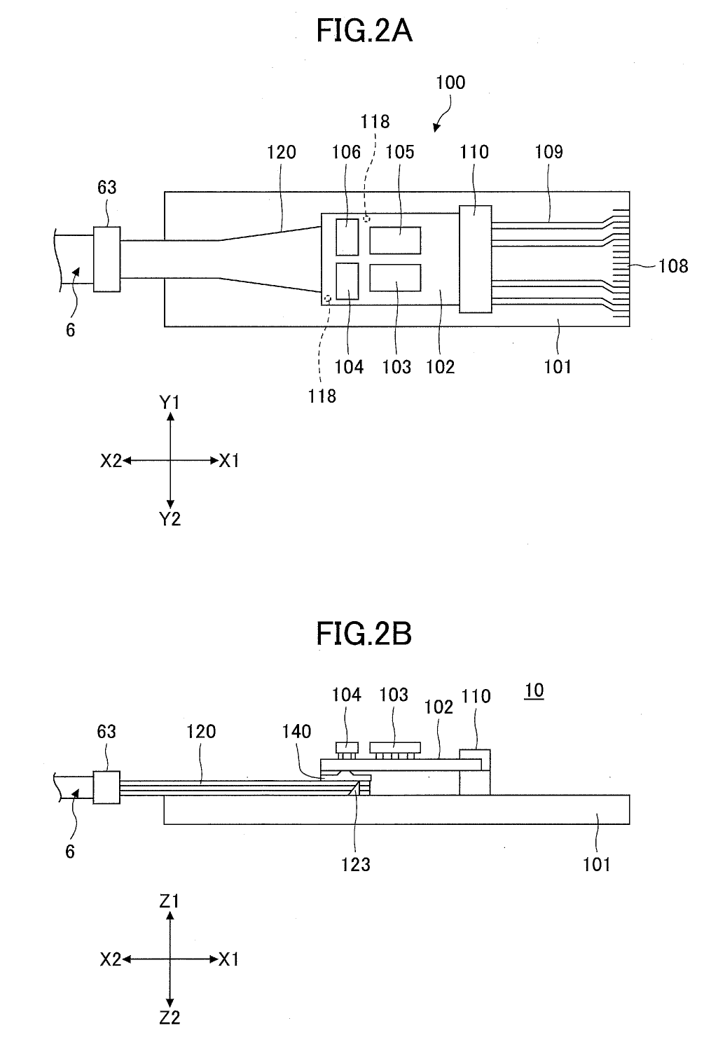

As illustrated by FIGS. 2A and 2B, the substrate 102, the TIA 103, the light-receiving device 104, the driving IC 105, the light-emitting device 106, an electric connector (“connector”) 110, the waveguide 120, and the lens sheet 140 are mounted on the board 101. Contacts 108 and wiring 109 are formed on the upper surface of the board 101. Alternatively, to increase the wiring density, the contacts 108 and the wiring 109 may be formed on the lower surface of the board 101.

The contacts 108 are formed at the module-side end of the wiring 109 as integral parts of the wiring 109. The contacts 108 function as an edge connector and are connected to a connector of the computer-side module when the optical connector 1 is attached to the computer-side module. The cable-side end of the wiring 109 is connected to the connector 110 mounted on the board 101.

The substrate 102 is attached to the connector 110. Accordingly, the substrate 102 is connected to the contacts 108 via the connector 110 and the board 101.

The light-receiving device 104 and the light-emitting device 106 are mounted on the upper surface of the substrate 102 in a “face-down” manner. The “face-down” mounting of the light-receiving device 104 and the light-emitting device 106 may be performed, for example, by a mounting method such as flip-chip bonding.

In the descriptions below, the light-receiving device 104 and the light-emitting device 106 may be collectively referred to as “optical devices”.

The light-receiving device 104 converts light, which is received via the waveguide 120, into an electric signal. The light-emitting device 106 converts an electric signal, which is received via the connector 110, into light.

The driving IC 105 drives the light-emitting device 106, and is disposed near the light-emitting device 106 on the substrate 102. The TIA 103 converts an electric current output from the light-receiving device 104 into a voltage, and is disposed near the light-receiving device 104 on the substrate 102.

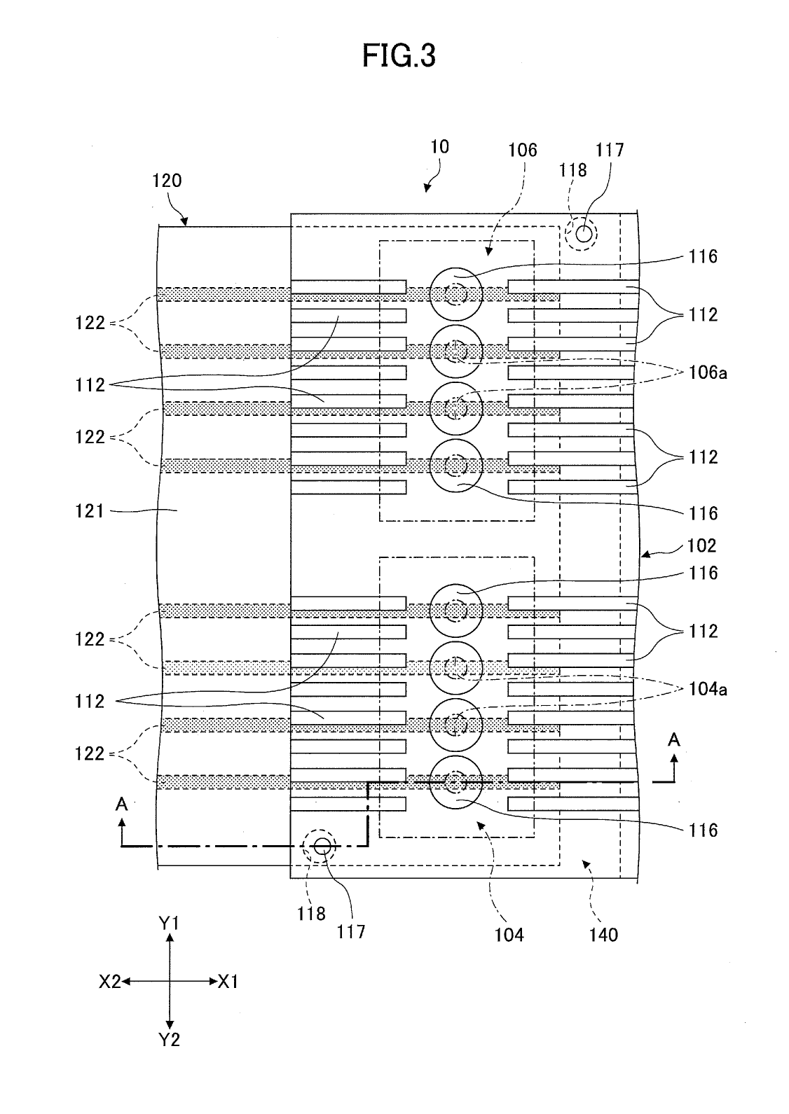

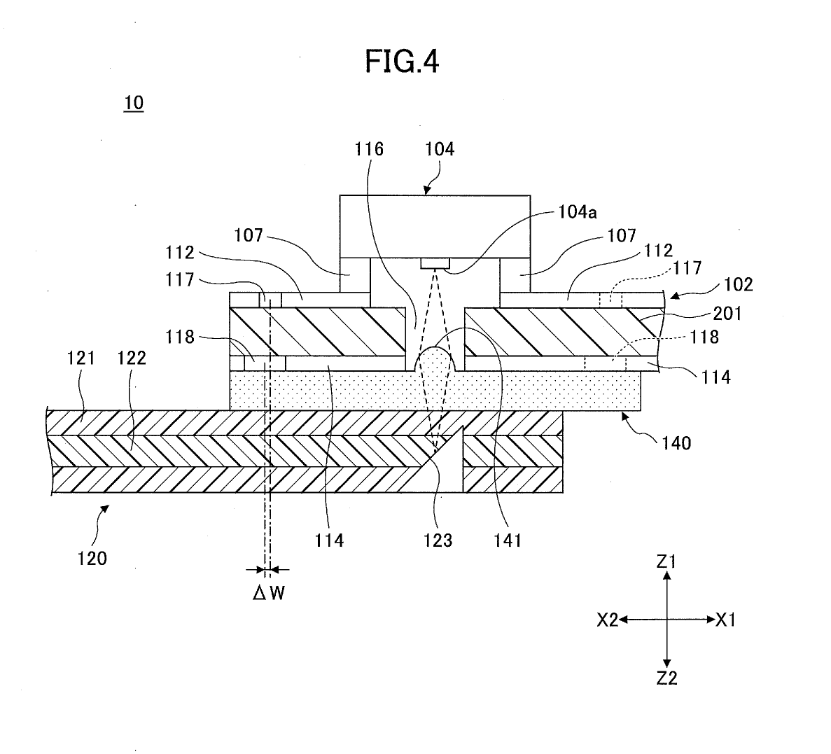

In the present embodiment, a vertical cavity surface emitting laser (VCSEL) is used as the light-emitting device 106. The VCSEL is a semiconductor laser. The light-emitting device 106 emits laser beams from light emitters 106a in a direction that is perpendicular to the board 101 (see FIGS. 3 and 4). Light passages 116 passing through the substrate 102 are formed at positions facing the light emitters 106a. The laser beams output from the light-emitting device 106 pass through the light passages 116 to the lower side of the substrate 102.

In the present embodiment, a photodiode (PD) with low power consumption is used as the light-receiving device 104. Light passages 116 are also formed at positions on the substrate 102 that face light receivers 104a of the light-receiving device 104. Light propagating through the waveguide 120 pass through the light passages 116 to the upper side of the substrate 102.

The light-emitting device 106 and the light-receiving device 104 may be implemented by other types of optical devices.

The waveguide 120 includes a film sheet 121 formed of a macromolecular polymer such as polyimide, and multiple waveguide cores (“cores”) 122 that transmit light. The cable-side end of the waveguide 120 is connected to the lens ferrule 6 via a boot 63. A mirror 123 is provided on the module side of the waveguide 120 at a position facing the light receivers 104a and the light emitters 106a. The light-receiving device 104 and the light-emitting device 106 are optically connected to the lens ferrule 6 via the waveguide 120.

As illustrated in FIG. 4, the lens sheet 140 made of a transparent material is disposed between the substrate 102 and the waveguide 120. Lenses 141, which are condenser lenses, are formed in parts of the lens sheet 140.

The lens sheet 140 is positioned such that the lenses 141 are positioned on the optical paths from the light receivers 104a and the light emitters 106a to the mirror 123.

Light emitted from the light-emitting device 106 travels downward, passes through the light passages 116, and reaches the waveguide 120. The mirror 123 is formed in the waveguide 120 at a position that faces the light-emitting device 106, and has a reflecting surface that is inclined at 45 degrees with respect to the vertical direction. Accordingly, the light is deflected degrees by the mirror 123. The deflected light travels through the cores 122 toward the cable side.

On the other hand, light traveled through the cores 122 is deflected upward by the mirror 123, passes through the light passages 116, and enters the light receivers 104a. Thus, the light-receiving device 104 and the light-emitting device 106 disposed on the upper surface of the substrate 102 are optically connected to the waveguide 120 disposed on the lower surface of the substrate 102 via the light passages 116.

Next, the substrate 102 is described in more detail.

As illustrated in FIGS. 3 and 4, the substrate 102 includes a polyimide substrate 201 on which an upper pattern 112, a lower pattern 114, upper markers 117, and lower markers 118 are formed.

The polyimide substrate 201 has a planar shape and is formed of polyimide that has optical transparency. Instead of the polyimide substrate 201, a substrate formed of another type of resin may be used. However, polyimide is preferably used as a resin material because in addition to having optical transparency, polyimide does not greatly degrade a high-frequency electric signal.

The upper pattern 112 and the upper markers 117 are formed on the upper surface of the polyimide substrate 201. The lower pattern 114 and the lower markers 118 are formed on the lower surface of the polyimide substrate 201.

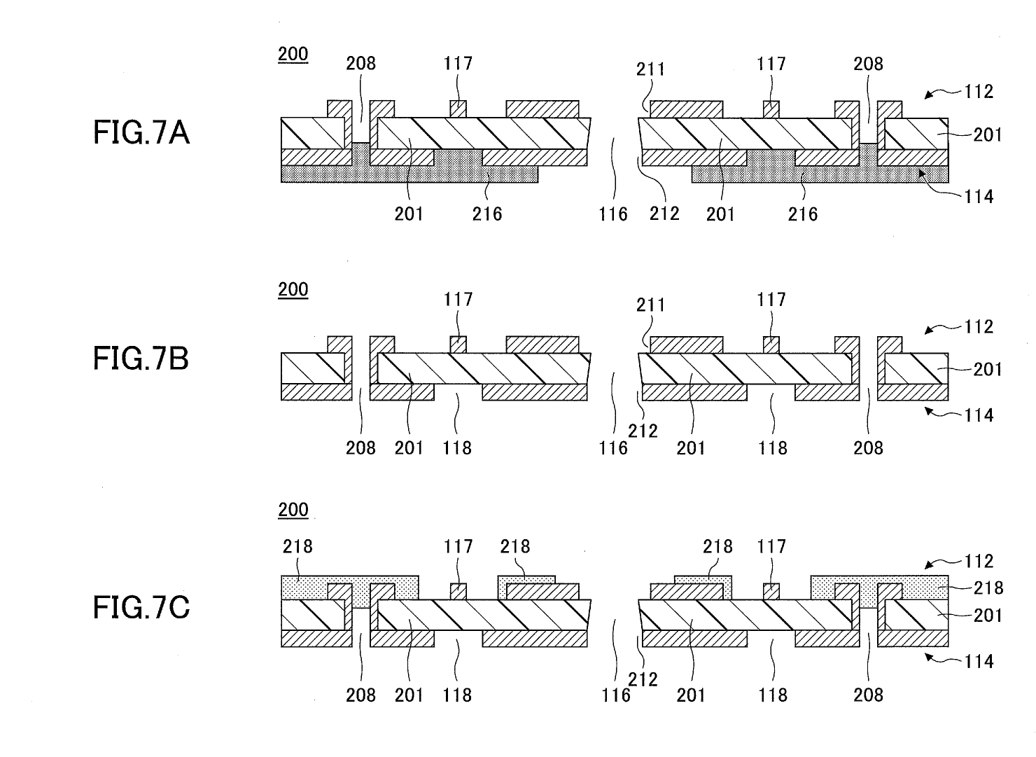

Through holes 208 are formed at predetermined positions in the substrate 102 to electrically connect the upper pattern 112 to the lower pattern 114 (see FIGS. 7A through 7C). The upper pattern 112 is connected to the optical devices via bumps 107. The upper pattern 112 and the lower pattern 114 are connected to the contacts 108 via the connector 110 and the board 101. Accordingly, the optical devices are connected to the contacts 108 via the substrate 102, the connector 110, and the board 101. A device having a signal shaping function such as a clock and data recovery (CDR) function may be provided between the connector 110 and the contacts 108.

As described later, the upper markers 117 are used to detect misalignment between the upper pattern 112 and the lower pattern 114. In the present embodiment, the upper markers 117 have a circular shape. However, the shape of the upper markers 117 can be freely determined. The upper markers 117 are formed together with the upper pattern 112 by using the same mask.

The lower markers 118 are used as reference positions when forming the light passages 116 in the polyimide substrate 201, and when mounting the optical devices on the substrate 102.

Each lower marker 118 is formed by removing a circular portion of a lower copper film 204 such that the polyimide substrate 201 is exposed at a position where the lower marker 118 is formed. The upper pattern 112 is not formed at positions on the upper surface of the substrate 102 that correspond to the positions where the lower markers 118 are formed.

With this configuration, the lower markers 118 formed on the lower surface of the substrate 102 are recognizable from the upper surface of the substrate 102.

In the present application, “the lower markers 118 are recognizable” indicates that the lower markers 118 are visible by the naked eye as well as that the lower markers 118 are detectable by an imaging device (e.g., a CCD camera).

The light passages 116 formed in the substrate 102 and the lower pattern 114 formed on the lower surface of the substrate 102 can be accurately positioned with reference to the directly-recognizable lower markers 118.

Also, the waveguide 120 and the lens sheet 140 can be accurately positioned on the lower surface of the substrate 102 with reference to the directly-recognizable lower markers 118.

The upper pattern 112 and the upper markers 117 are formed on the upper surface of the substrate 101 using a mask that is different from the mask used to form the lower pattern 114 and the lower markers 118. For this reason, there is a risk that misalignment occurs between “the upper pattern 112 and the upper markers 117” and “the lower pattern 114 and the lower markers 118”.

However, because the substrate 102 of the present embodiment is configured such that the lower markers 118 are recognizable from the upper surface, it is possible to accurately position the light-receiving device 104 and the light-emitting device 106 on the upper surface of the substrate 102 by detecting misalignment between the lower markers 118 and the upper pattern 112 based on the lower markers 118 as a reference. All of the light-receiving device 104, the light-emitting device 106, and the light passages 116 can be accurately positioned with reference to the lower markers 118.

Accordingly, laser beams emitted from the light-emitting device 106 pass through the light passages 116 and the lenses 141, are reflected by the mirror 123, and enter the cores 122 with high efficiency. Also, an optical signal received via the cores 122 is reflected by the mirror 123, passes through the light passages 116, and enters the light-receiving device 104. Thus, the present embodiment can reduce the optical loss between each of the optical devices and the waveguide 120.

Next, characteristics of the polyimide substrate 201 are described.

To accurately position the light-receiving device 104, the light-emitting device 106, and the light passages 116, the lower markers 118 need to be recognizable from the upper surface of the polyimide substrate 201. Accordingly, the polyimide substrate 201 needs to have optical transparency so that the lower markers 118 can be seen from the upper surface. The optical transparency is greatly influenced by the roughness of a substrate surface.

FIG. 5 illustrates the results of an experiment where substrates with different degrees of roughness were prepared, the lower markers 118 were formed on the lower surface of each of the substrates, and the recognizability of the lower markers 118 from the upper surface was measured for each of the substrates.

In the experiment, three substrates were prepared as Example 1, Example 2, and Comparative Example. The base material of all of the substrates is polyimide, and the substrates have the same thickness.

A copper film is formed by metallizing on the substrate of Example 1, by casting on the substrate of Example 2, and by lamination on the substrate of Comparative Example. As the roughness, ten-point average roughness of each of the substrates was measured. Further, the optical loss of each of the substrates was measured.

The results of FIG. 5 indicate that the recognizability of the lower markers 118 from the upper surface of the polyimide substrate 201 varies depending on the method of forming the copper film.

In Example 1 where a Cu film is formed by metallizing, the lower markers 118 were well recognizable from the upper surface. In Example 1, the roughness was nearly zero (≈0), and the optical loss was 0.1 dB.

In Example 2 where a Cu film is formed by casting, the lower markers 118 were also well recognizable from the upper surface. In Example 2, the roughness was 0.6, and the optical loss was 0.33 dB.

On the other hand, in Comparative Example where a Cu film is formed by lamination, the recognizability of the lower markers 118 was poor compared with Examples 1 and 2, and it was not possible to recognize the positions of the lower markers 118 at such a degree that the light-receiving device 104 and the light-emitting device 106 can be accurately mounted. In Comparative Example, the roughness was 2.0, and the optical loss was 2.66 dB.

Based on the results of the experiment of FIG. 5, it was found out that the recognizability of the lower markers 118 from the upper surface of the polyimide substrate 201 becomes good when the Cu film is formed by metallizing or casting.

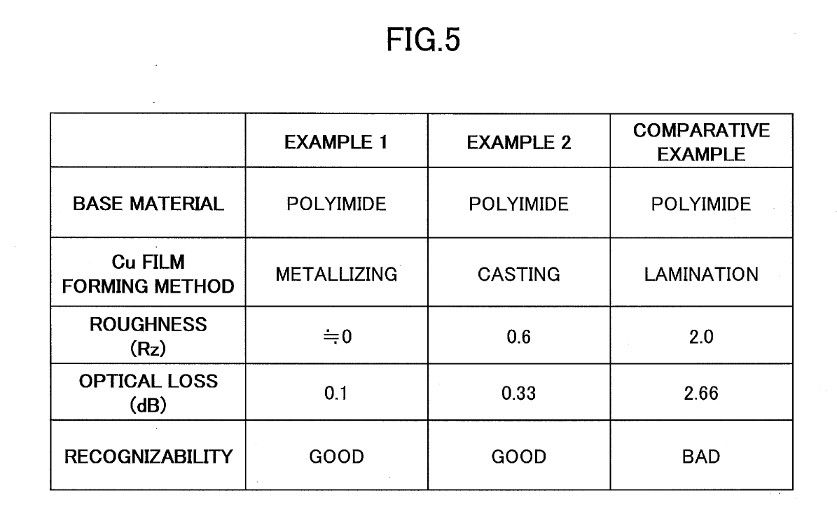

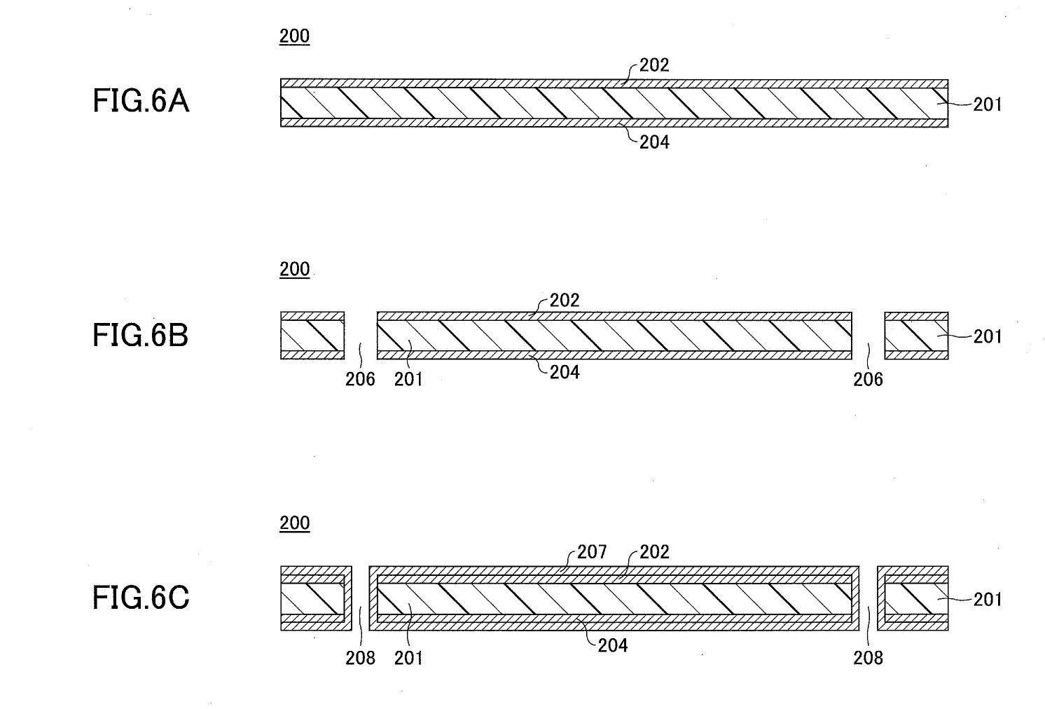

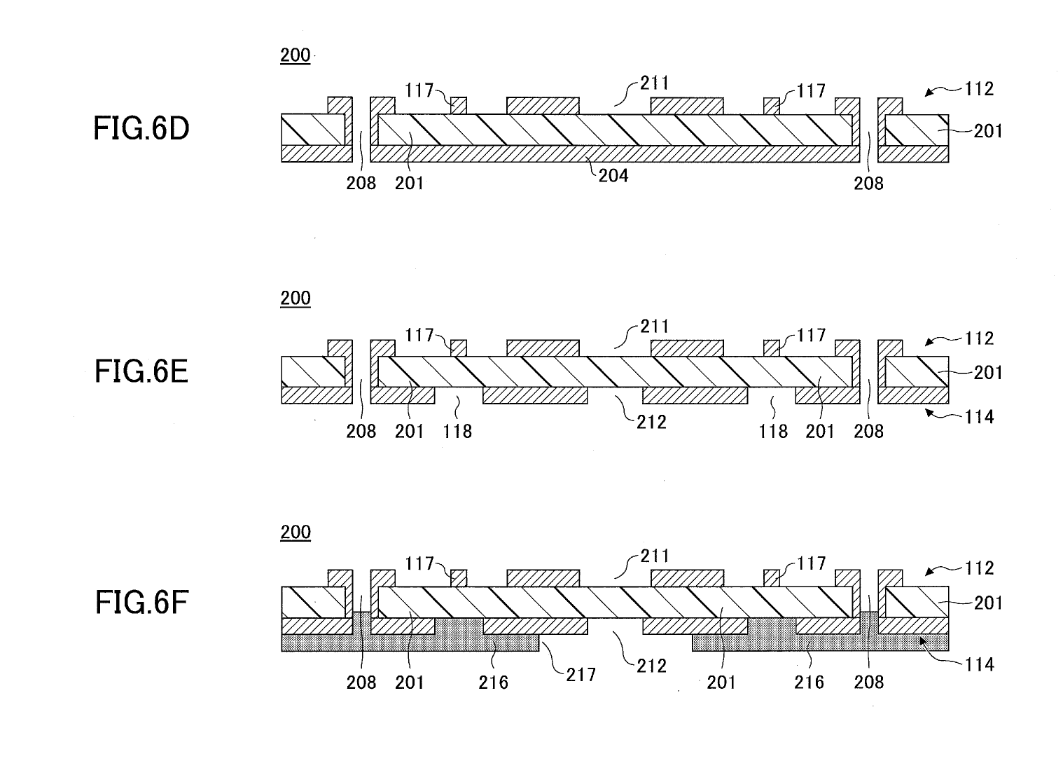

Next, an exemplary method of producing the optical connector 1 is described with reference to FIGS. 6A through 8C.

Below, an exemplary method of preparing the substrate 102 and mounting the optical devices on the substrate 102 is described. The same reference numbers as those in FIGS. 1 through 4 are assigned to the corresponding components in FIGS. 6A through 8C, and repeated descriptions of those components may be omitted.

FIG. 6A illustrates an example of a double-copper-laminated substrate 200. The substrate 200 includes the polyimide substrate 201, an upper copper film 202 formed on the upper surface of the polyimide substrate 201, and a lower copper film 204 formed on the lower surface of the polyimide substrate 201.

It is preferable to form at least the lower copper film 204 by metallizing or casting. In the present embodiment, both of the upper copper film 202 and the lower copper film 204 are formed by metallizing or casting.

The ten-point average roughness (Rz) of the upper surface of the polyimide substrate 201 is greater than or equal to 0 and less than or equal to 2.0, and the optical loss of the polyimide substrate 201 is greater than or equal to 0.1 dB and less than or equal to 2.7 dB.

The upper copper film 202 is formed on the entire upper surface of the polyimide substrate 201 to have a constant thickness. The lower copper film 204 is formed on the entire lower surface of the polyimide substrate 201 to have a constant thickness.

As illustrated by FIG. 6B, holes 206 are formed in the substrate 200. The holes 206 are drilled using a numerical control (NC) machine tool. The holes 206 may also be formed using other types of machine such as a laser-beam machine.

After the holes 206 are formed, through-hole plating is performed. Specifically, after a desmear process is performed on the holes 206, thin copper films are formed on the inner surfaces of the holes 206 by electroless plating. Next, electrolytic copper plating is performed using the copper films formed on the inner surfaces of the holes 206, the upper copper film 202, and the lower copper film 204 as electrodes to form a plated film 207 on the entire surface of the substrate 200 including the inner surfaces of the holes 206. As a result, as illustrated by FIG. 6C, through holes 208 are formed.

After the through holes 208 are formed, the upper pattern 112 is formed by a known lithography process.

In forming the upper pattern 112, a resist is applied to the upper surface of the substrate 200, and is patterned by exposing the resist using a mask with a predetermined pattern, and developing the resist. Next, the upper copper film 202 and the plated film 207 are etched using the patterned resist as a mask, and then the resist is removed to form the upper pattern 112. The upper markers 117 are also formed using the same mask when the upper pattern 112 is formed.

When the upper pattern 112 is formed, openings 211 are formed at positions where the light passages 116 are to be formed. FIG. 6D illustrates the substrate 200 on which the upper pattern 112 is formed.

After the upper pattern 112 is formed, the lower pattern 114 is formed by a lithography process similar to the upper pattern 112. FIG. 6E illustrates the substrate 200 on which the lower pattern 114 is formed.

When the lower pattern 114 is formed, the lower markers 118 and openings 212 are also formed using the same mask. Accordingly, the lower markers 118 and the openings 212 can be accurately positioned relative to each other.

After the upper pattern 112 and the lower pattern 114 are formed, a mask 216 is formed on the lower surface of the substrate 200 as illustrated by FIG. 6F. The mask 216 includes openings 217 to expose the openings 212 of the lower pattern 114. The mask 216 is formed to prevent parts of the polyimide substrate 201 exposed in the lower markers 118 and the openings 212 from being removed in a later step.

Next, using the lower pattern 114 as a mask, the light passages 116 are formed in the polyimide substrate 201. The light passages 116 can be formed by wet etching. Specifically, the polyimide substrate 201 is etched by using a polyimide chemical etching liquid that does not dissolve copper but dissolves only polyimide. An example of the polyimide chemical etching liquid is a non-hydrazine alkaline liquid.

The light passages 116 may be formed in the polyimide substrate 201 by laser processing instead of wet etching. Also when laser processing is used, the lower pattern 114 including the openings 212 is used as a mask.

FIG. 7A illustrates the substrate 200 after the light passages 116 are formed using the lower pattern 114 as a mask. That is, the light passages 116 are formed based on the positions of the openings 212.

Accordingly, the positions of the light passages 116 accurately match the positions of the openings 212. Also, because the lower markers 118 and the openings 212 are formed using the same mask, they are accurately positioned relative to each other. Therefore, the lower markers 118 and the light passages 116 are accurately positioned relative to each other.

After the light passages 116 are formed, the mask 216 is removed as illustrated by FIG. 7B. Next, as illustrated by FIG. 7C, a solder resist 218 is formed on the upper surface of the polyimide substrate 201, on the upper pattern 112, and in the through holes 208. The solder resist 218 is not formed on the upper markers 117, parts of the upper pattern 112 where the optical devices are to be mounted, and parts of the polyimide substrate 201 corresponding to the lower markers 118.

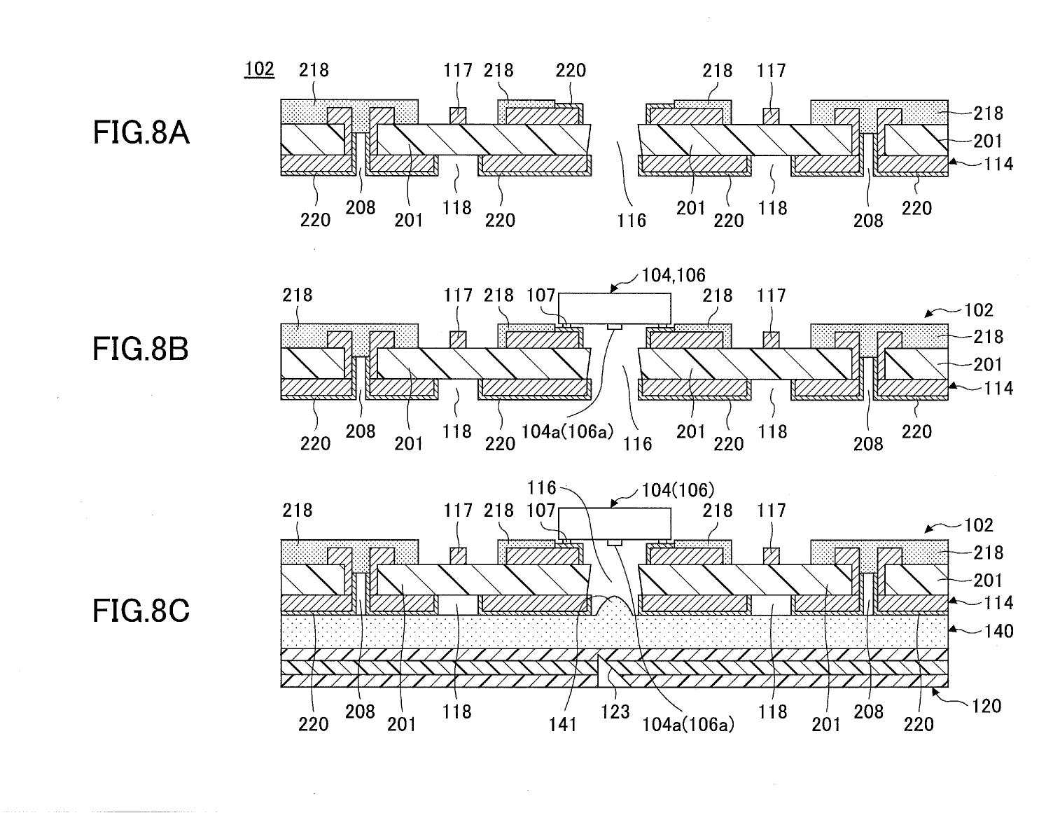

Next, an Au film 220 is formed by gold plating on parts of the upper pattern 112 that are exposed through the solder resist 218 and on the lower pattern 114. The Au film 220 functions as a protection film for protecting the upper pattern 112 and the lower pattern 114. Through the above steps, the substrate 102 as illustrated by FIG. 8A is prepared.

Then, the light-receiving device 104 and the light-emitting device 106 are mounted on the substrate 102. FIG. 8B illustrates the substrate 102 on which the optical devices are mounted.

The light-receiving device 104 and the light-emitting device 106 are mounted on the substrate 102 using the lower markers 118. The lower markers 118 formed on the lower surface of the substrate 102 are recognizable from the upper surface because the polyimide substrate 201 is optically transparent.

The light-receiving device 104 and the light-emitting device 106 are positioned with reference to the lower markers 118 that can be seen through the polyimide substrate 201, and mounted on the upper pattern 112. Also, as described above, the light passages 116 are formed with reference to the lower markers 118. Thus, all of the light-receiving device 104, the light-emitting device 106, and the light passages 116 can be accurately positioned with reference to the lower markers 118.

After the optical devices are mounted, the lens sheet 140 and the waveguide 120 are mounted on the substrate 102 with reference to the lower markers 118.

Because the lens sheet 140, the waveguide 120, the light-receiving device 104, and the light-emitting device 106 are mounted on the substrate 102 with reference to the same lower makers 118, they are accurately positioned relative to each other. Also, because the light passages 116 and the lower markers 118 are positioned using the same mask, they are accurately positioned relative to each other.

When the optical devices are mounted on the upper pattern 112 with reference to the lower markers 118, the optical devices may be misaligned with the upper pattern 112. If amount of this misalignment is large, the optical devices may not be properly connected to the upper-surface pattern 112 by flip-chip bonding.

This connection error or the misalignment of the optical devices with the upper pattern 112 can be prevented by measuring the amount of misalignment ΔW (see FIG. 4) between the center of each upper marker 117 and the center of the corresponding lower marker 118, and by correcting the mounting position of the corresponding optical device based on the amount of misalignment ΔW. More specifically, when the amount of misalignment ΔW is too large to be able to properly perform flip-chip bonding, the mounting positions of the optical devices are corrected or the substrate 102 is not used for the subsequent production process to prevent connection errors.

Instead of the polyimide substrate 201, a substrate formed of any other material may be used as long as the lower markers 118 are recognizable from the upper surface of the substrate.

When a substrate with low optical transparency is used instead of the polyimide substrate 201, the recognizability or visibility of the lower markers 118 through the substrate 102 becomes low due to low contrast. Also, when a substrate with no optical transparency is used, it is not possible to recognize or see the lower markers 118 through the substrate 102.

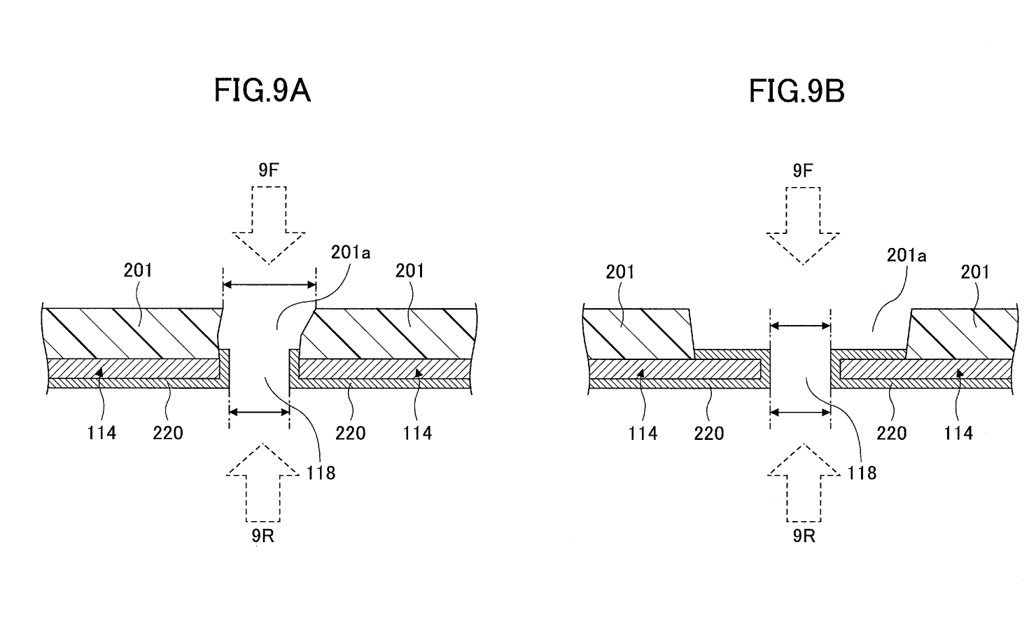

In such a case, as illustrated by FIG. 9A, a portion of the polyimide substrate 201 corresponding to the lower marker 118 may be removed to form an opening 201a so that the lower marker 118 can be recognized from the upper surface and the lower surface.

However, when the opening 201a is formed using the lower pattern 114 around the lower marker 118 as a mask, the edge of the opening 201a formed in the polyimide substrate 201 may become rough as illustrated in FIG. 9A. As a result, the position of the lower marker 118 recognized from the upper surface of the substrate 102 (9F) may become different from the position of the lower marker 118 recognized from the lower surface of the substrate 102 (9R), and it may become difficult to position components accurately.

For this reason, the opening 201a may be formed by removing a portion of the polyimide substrate 201 that is sufficiently wider than the lower marker 118 as illustrated by FIG. 9B so that the lower marker 118 can be equally recognized from both the upper surface and the lower surface of the substrate 102 as indicated by 9F and 9R. This configuration can prevent a problem where the position of the lower marker 118 recognized from the upper surface of the substrate 102 becomes different from the position of the lower marker 118 recognized from the lower surface of the substrate 102, and makes it possible to perform accurate positioning of components.

When the shape of the lower marker 118 is the same as the shape of the opening 201a of the polyimide substrate 201, the opening 201a may be misidentified as the lower marker 118 in image recognition. Therefore, the shape of the lower marker 118 is preferably different from the shape of the opening 201a. For example, when the lower marker 118 is formed in a circular shape, the opening 201a may be formed in a quadrangular shape.

In the above embodiment, the lower marker 118 is formed as an opening by removing a portion of the lower copper film 204. However, the lower marker 118 may instead be formed by leaving a portion of the lower copper film 204.

An optical connector and a method of producing the optical connector according to the embodiment of the present invention are described above. However, the present invention is not limited to the specifically disclosed embodiment, and variations and modifications may be made without departing from the scope of the present invention.

What is claimed is:

1. An optical connector, comprising:
an optically-transparent substrate;
a first optical component mounted on a first surface of the substrate; and
a second optical component mounted on a second surface of the substrate,
wherein the substrate includes a marker that is formed on one of the first surface and the second surface and recognizable from another one of the first surface and the second surface.

2. The optical connector as claimed in claim 1, further comprising:
a metal film formed on the substrate,
wherein the marker is formed in the metal film.

3. The optical connector as claimed in claim 2, wherein
an opening having a width that is wider than a width of the marker is formed in the substrate at a position corresponding to the marker.

4. The optical connector as claimed in claim 1, wherein
the first optical component is an optical device;
the second optical component is an optical waveguide; and
the optical device and the optical waveguide are optically connected to each other via a light passage formed in the substrate.

5. A method for producing an optical connector, the method comprising:
forming a marker and a positioning part in a first surface of an optically-transparent substrate by using a same mask;
forming a light passage in the substrate with reference to the positioning part; and
mounting a first optical component on the first surface of the substrate and mounting a second optical component on a second surface of the substrate with reference to the marker such that the first optical component and the second optical component are optically connected to each other via the light passage.
